(19) United States
(12) Patent Application Publication
(10) Pub. No.: US 2011/0096941 A1
(43) Pub. Date: Apr. 28, 2011

(54) SELF-STEERING DIRECTIONAL LOUDSPEAKERS AND A METHOD OF OPERATION THEREOF

(75) Inventors: Thomas L. Marzetta, Summit, NJ (US); Stanley Chow, Ottawa (CA)

(73) Assignees: Alcatel-Lucent USA, Incorporated, Murray Hill, NJ (US); Alcatel-Lucent Canada, Incorporated, Kanata (CA)

(21) Appl. No.: 12/607,919

(22) Filed: Oct. 28, 2009

(51) Int. Cl. H04R 3/00

(52) U.S. Cl. 381/92

(57) ABSTRACT

A directional sound system, a method of transmitting sound to a spatial location determined by the gaze of a user and a directional communication system are disclosed. In one embodiment, the directional sound system includes: (1) a direction sensor configured to produce data for determining a direction in which attention of a user is directed, (2) a microphone configured to generate output signals indicative of sound received thereat, (3) loudspeakers configured to convert directed sound signals into directed sound and (4) an acoustic processor configured to be coupled to the direction sensor, the microphone, and the loudspeakers, the acoustic processor configured to convert the output signals to the directed sound signals and employ the loudspeakers to transmit the directed sound to a spatial location associated with the direction.

### TECHNICAL FIELD

This application is directed, in general, to speakers and, more specifically, to directing sound transmission.

### BACKGROUND

Acoustic transducers are used when converting sound from one form of energy to another form of energy. For example, microphones are used to convert sound to electrical signals (i.e., an acoustic-to-electric transducer). The electrical signals can then be processed (e.g., cleaned-up, amplified) and transmitted to a speaker or speakers (hereinafter referred to as a loudspeaker or loudspeakers). The loudspeakers are then used to convert the processed electrical signals back to sound (i.e., an electric-to-acoustic transducer).

Often, such as in a concert or a speech, the loudspeakers are arranged to provide audio-coverage throughout an area. In other words, the loudspeakers are arranged to propagate sound received from a microphone or microphones throughout a designated area. Therefore, each person in the area is able to hear the transmitted sound.

### SUMMARY

One aspect provides a directional sound system. In one embodiment, the directional sound system includes: (1) a direction sensor configured to produce data for determining a direction in which attention of a user is directed, (2) a microphone configured to generate output signals indicative of sound received thereat, (3) loudspeakers configured to convert directed sound signals into directed sound and (4) an acoustic processor configured to be coupled to the direction sensor, the microphone, and the loudspeakers, the acoustic processor configured to convert the output signals to the directed sound signals and employ the loudspeakers to transmit the directed sound to a spatial location associated with the direction.

Another aspect provides a method of transmitting sound to a spatial location determined by the gaze of a user. In one embodiment, the method includes: (1) determining a direction of visual attention of a user associated with a spatial location, (2) generating directed sound signals indicative of sound received from a microphone, (3) converting the directed sound signals to directed sound employing loudspeakers having known positions relative to one another and (4) transmitting the directed sound in the direction employing the loudspeakers to provide directed sound at the spatial location.

Still yet another aspect provides a directional communication system. In one embodiment, the directional communication system includes: (1) an eyeglass frame, (2) a direction sensor on the eyeglass frame and configured to provide data indicative of a direction of visual attention of a user wearing the eyeglass frame, (3) a microphone configured to generate output signals indicative of sound received thereat, (4) acoustic transducers arranged in an array and configured to provide output signals indicative of sound received at the microphone and (5) an acoustic processor coupled to the direction sensor, the microphone, and the acoustic transducers, the acoustic processor configured to convert the output signals to directed sound signals and employ the acoustic transducers to transmit directed sound based on the directed sound signals to a spatial location associated with the direction.

### BRIEF DESCRIPTION

Reference is now made to the following descriptions taken in conjunction with the accompanying drawings, in which:

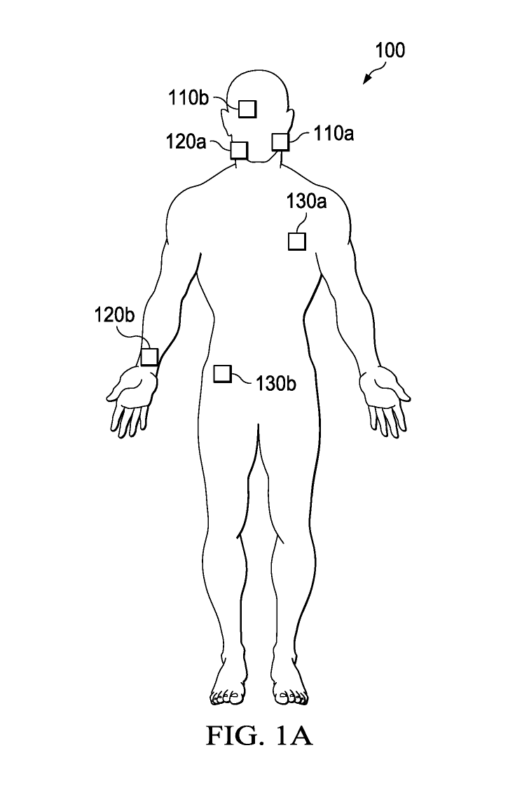

FIG. 1A is a highly schematic view of a user indicating various locations thereon at which components of a directional sound system constructed according to the principles of the disclosure may be located;

FIG. 1B is a high-level block diagram of one embodiment of a directional sound system constructed according to the principles of the disclosure;

FIG. 1C is a high-level block diagram of one embodiment of a directional communication system constructed according to the principles of the disclosure;

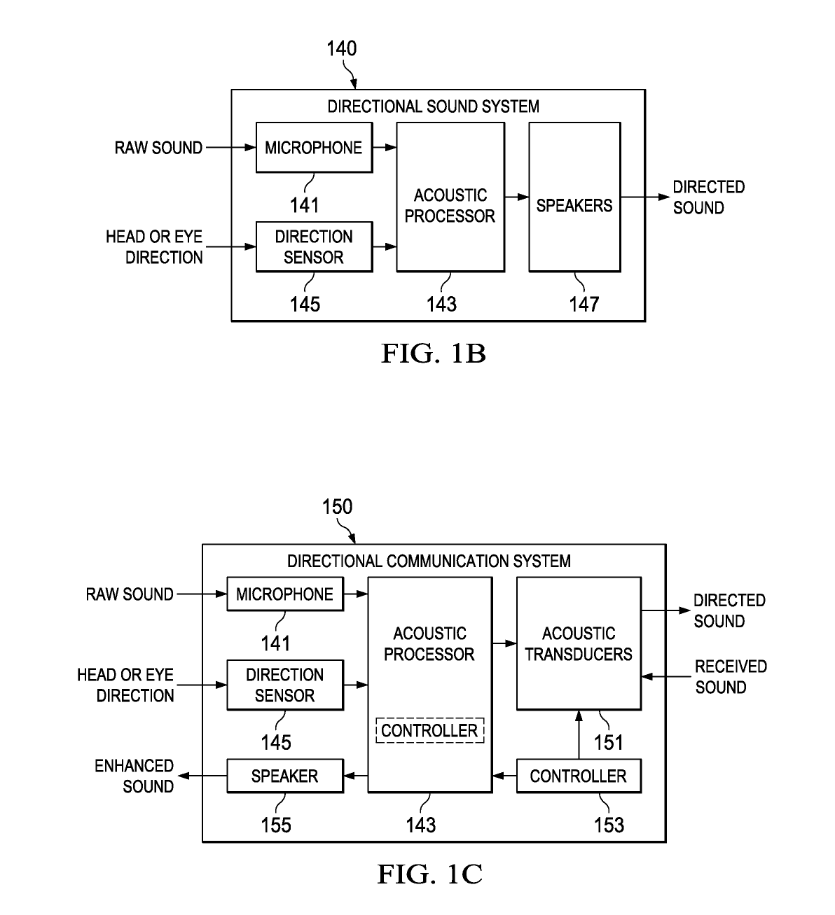

FIG. 2A schematically illustrates a relationship between the user of FIG. 1A, a point of gaze of the user and an array of loudspeakers;

FIG. 2B schematically illustrates one embodiment of a non-contact optical eye tracker that may constitute the direction sensor of the directional sound system of FIG. 1A;

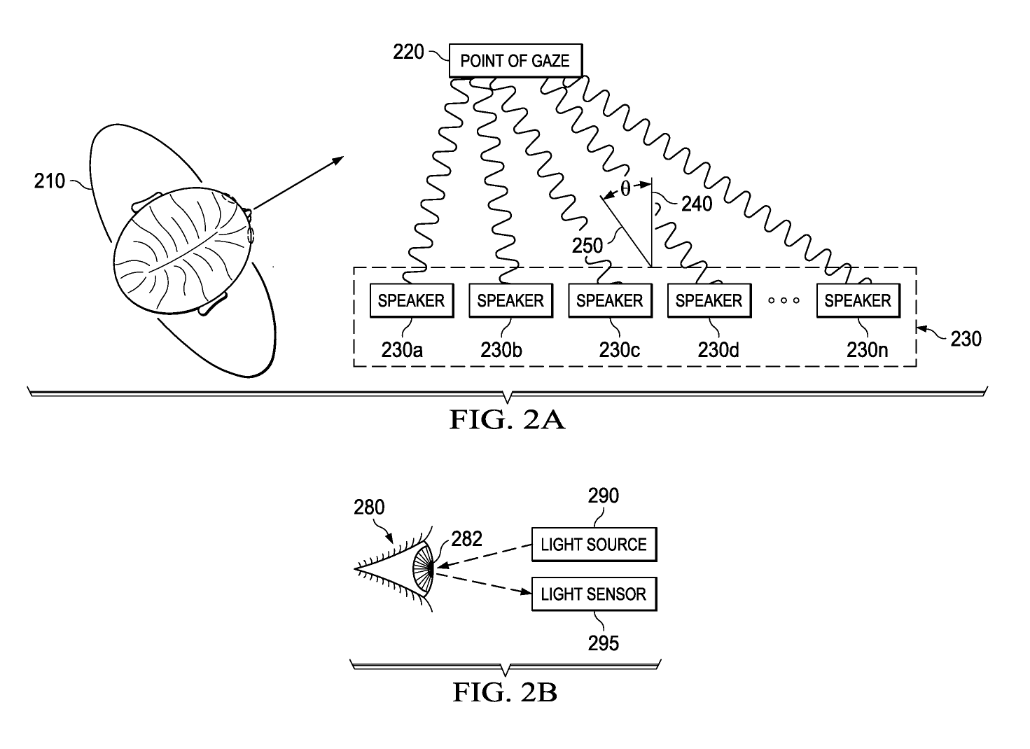

FIG. 3 schematically illustrates one embodiment of a directional sound system having an accelerometer and constructed according to the principles of the disclosure;

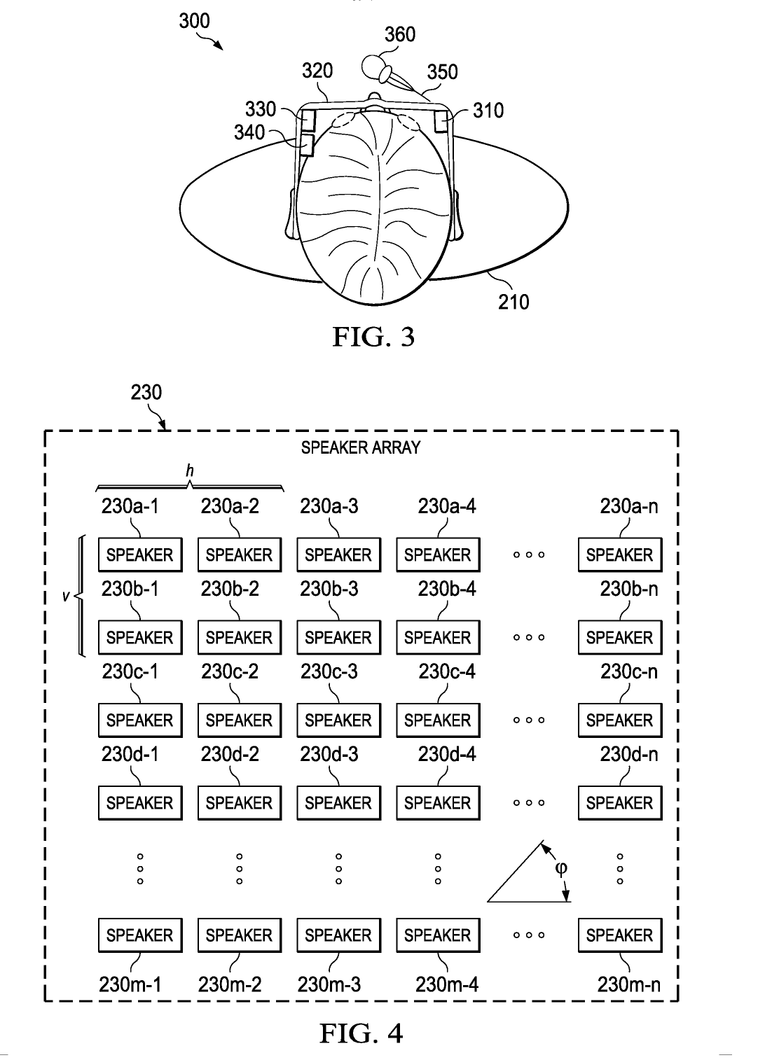

FIG. 4 illustrates a substantially planar two-dimensional array of loudspeakers;

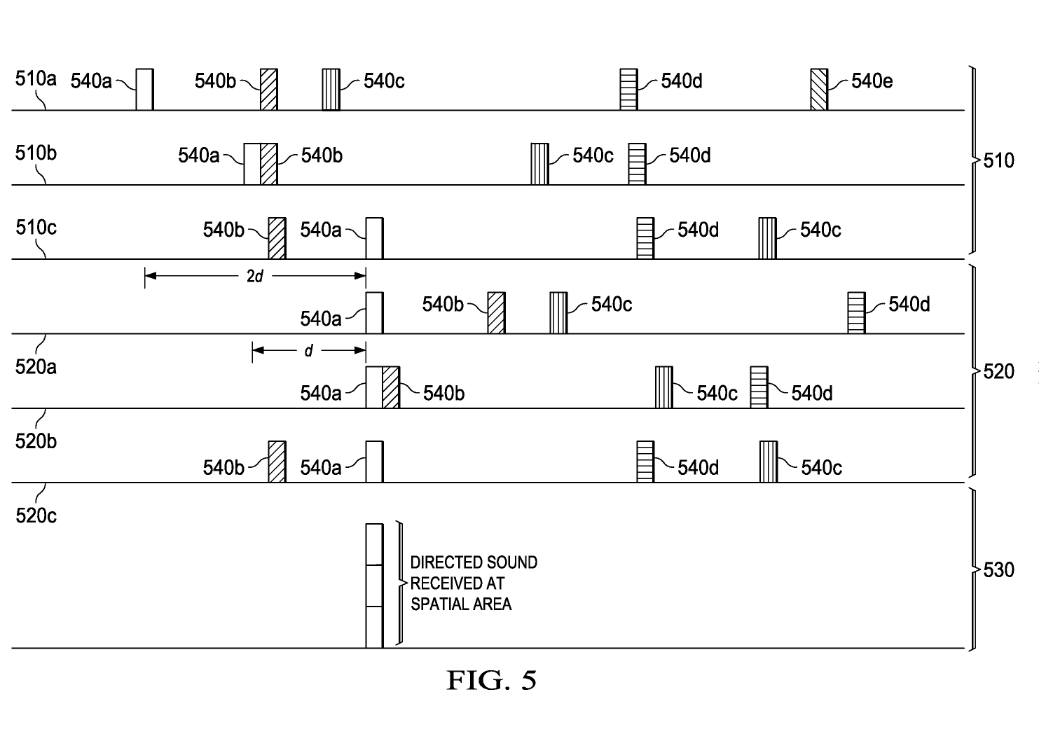

FIG. 5 illustrates three output signals of three corresponding acoustic transducers and integer multiple delays thereof that are used to determine transmitting delays to use with the acoustic transducers to transmit directed sound signals to a spatial location to provide delay-and-sum beamforming thereat; and

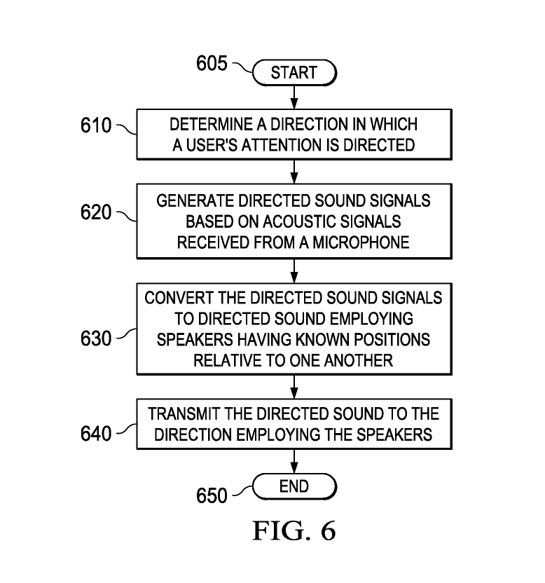

FIG. 6 is a flow diagram of an embodiment of transmitting sound to a spatial location determined by the gaze of a user carried out according to the principles of the disclosure.

### DETAILED DESCRIPTION

Instead of propagating sound throughout an area, this disclosure addresses how sound can be directed to a spatial location (e.g., a spatial volume). As such, a human speaker can direct the sound of his voice selectively to a spatial location. Thus, a speaker could selectively speak to another person while limiting the ability of other people in the area to hear what is spoken. In some embodiments, the speaker could selectively speak over a considerable distance to another person.

As disclosed herein, a steerable loudspeaker array can be combined with a direction sensor to direct sound. The steerable loudspeaker array may be electronically-steerable or even mechanically-steerable. The user could speak (or whisper) into a microphone, and the sound of his voice can be transmitted selectively by the loudspeaker array towards the point in space, or even points in space, at which the user is looking. This may be performed without requiring special equipment for the party towards whom the sound is directed. The sound may be transmitted to the point in space in stereo.

The direction sensor may be an eye-tracking device such as a non-contact eye-tracker that is based on infrared light reflected from a cornea. Nanosensors may be used to provide a compact eye-tracker that could be built into eye-glass frames. Other types of direction sensors, such as a head tracking device, may also be used.

The loudspeaker array is to be sufficiently large enough (both with respect to spatial extent and the number of loudspeakers) to provide a desired angular resolution for directing the sound. The loudspeaker array may include loudspeakers built into the user's clothing and additional loudspeakers coupled to these loudspeakers to augment the user's array. The additional loudspeakers may be wirelessly linked. The additional loudspeakers may be attached to other users or fixed at various locations.

Processing of the acoustic signals may occur in real-time. Under line-of-sight propagation conditions, delay-and-sum beamforming could be used. Under multipath conditions, a more general filter-and-sum beamformer might be effective. If the user were directing the sound to another human speaker, and if the other user spoke, then reciprocity would aid the beamforming process. In some embodiments, a microphone array can be co-located with a loudspeaker array. The microphone array, for example, may be the array disclosed in U.S. patent application Ser. No. 12/238,346, entitled “SELF-STEERING DIRECTIONAL HEARING AID AND METHOD OF OPERATION THEREOF,” by Thomas L. Marzetta, filed on Sep. 25, 2008, and incorporated herein by reference in its entirety and referred to herein as Marzetta. Instead of a separate array of microphones, an array of acoustic transducers may be used that operate as both microphones and loudspeakers.

FIG. 1A is a highly schematic view of a user 100 indicating various locations thereon at which various components of a directional sound system constructed according to the principles of the disclosure may be located. In general, such a directional sound system includes a direction sensor, a microphone, an acoustic processor and loudspeakers.

In one embodiment, the direction sensor is associated with any portion of the head of the user 100 as a block 110a indicates. This allows the direction sensor to produce a head position signal that is based on the direction in which the head of the user 100 is pointing. In a more specific embodiment, the direction sensor is proximate one or both eyes of the user 100 as a block 110b indicates. This allows the direction sensor to produce an eye position signal based on the direction of the gaze of the user 100. Alternative embodiments locate the direction sensor in other places that still allow the direction sensor to produce a signal based on the direction in which the head or one or both eyes of the user 100 are pointed. A pointing device may also be used with a direction sensor to indicate a spatial location. For example, as represented by block 120b, the user 100 may use a direction sensor with a directional indicator, such as a wand or a laser beam, to associate movements of a hand with a location signal that indicates the spatial location. The directional indicator may wirelessly communicate with a direction sensor to indicate the spatial location based on movements of the directional indicator by the hand of the user. In some embodiments, the directional indicator may be connected to the direction sensor via a wired connection.

The direction sensor may be used to indicate two or more spatial locations based on head positions or gaze points of the user 100. As such, the loudspeakers can be positioned to simultaneously transmit sound to each of the different spatial locations. For example, a portion of the loudspeakers may be positioned to transmit directed sound to one spatial location while other loudspeakers may be positioned to simultaneously transmit the directed sound to another or other spatial locations. Additionally, the size of the spatial location identified by the user 100 may vary based on the head positions or gaze points of the user. For example, the user 100 may indicate that the spatial location is a region by moving his eyes in a circle. Thus, instead of multiple distinct spatial locations for simultaneous transmission, the loudspeakers may be directed to transmit sound to a single, contiguous spatial location that could include multiple people.

The microphone is located proximate the user 100 to receive sound to be transmitted to a spatial location according to the direction sensor. In one embodiment, the microphone is located proximate the mouth of the user 100, as indicated by block 120a, to capture the user's voice for transmission. The microphone may be attached to clothing worn by the user 100 using a clip. In some embodiments, the microphone may be attached to the collar of the clothing (e.g., a shirt, a jacket, a sweater or a poncho). In other embodiments, the microphone may be located proximate the mouth of the user 100 via an arm connected to a headset or eyeglass frame. The microphone may also be located proximate the arm of the user 100 as indicated by a block 120b. For example, the microphone may be clipped to a sleeve of the clothing or attached to a bracelet. As such, the microphone can be placed proximate the mouth of the user when desired by the user.

In one embodiment, the loudspeakers are located within a compartment that is sized such that it can be placed in a shirt pocket of the user 100 as a block 130a indicates. In an alternative embodiment, the loudspeakers are located within a compartment that is sized such that it can be placed in a pants pocket of the user 100 as a block 130b indicates. In another alternative embodiment, the loudspeakers are located proximate the direction sensor, indicated by the block 110a or the block 110b. The aforementioned embodiments are particularly suitable for loudspeakers that are arranged in an array. However, the loudspeakers need not be so arranged. Therefore, in yet another alternative embodiment, the loudspeakers are distributed between or among two or more locations on the user 100, including but not limited to those indicated by the blocks 110a, 110b, 130a, 130b. In still another alternative embodiment, one or more of the loudspeakers are not located on the user 100 (i.e., the loudspeakers are located remotely from the user), but rather around the user 100, perhaps in fixed locations in a room in which the user 100 is located. One of more of the loudspeakers may also be located on other people around the user 100 and wirelessly coupled to other components of the directional sound system.

In one embodiment, the acoustic processor is located within a compartment that is sized such that it can be placed in a shirt pocket of the user 100 as the block 130a indicates. In an alternative embodiment, the acoustic processor is located within a compartment that is sized such that it can be placed in a pants pocket of the user 100 as the block 130b indicates. In another alternative embodiment, the acoustic processor is located proximate the direction sensor, indicated by the block 110a or the block 110b. In yet another alternative embodiment, components of the acoustic processor are distributed between or among two or more locations on the user 100, including but not limited to those indicated by the blocks 110a, 110b, 120a, 120b. In still other embodiments, the acoustic processor is co-located with the direction sensor, with the microphone or one or more of the loudspeakers.

FIG. 1B is a high-level block diagram of one embodiment of a directional sound system 140 constructed according to the principles of the disclosure. The directional sound system 140 includes a microphone 141, an acoustic processor 143, a direction sensor 145 and loudspeakers 147.

The microphone 141 is configured to provide output signals based on received acoustic signals, called “raw sound” in FIG. 1B. The raw sound is typically the voice of a user. In some embodiments, multiple microphones may be used to receive the raw sound from a user. In some embodiments, the raw sound may be from a recording or may be relayed through the microphone 141 from another sound source than the user. For example, an RF transceiver may be used to receive the raw sound that is the basis for the output signals from the microphone.

The acoustic processor 143 is coupled by wire or wirelessly to the microphone 141 and the loudspeakers 147. The acoustic processor 143 may be a computer including a memory having a series of operating instructions that direct its operation when initialized thereby. The acoustic processor 143 is configured to process and direct the output signals received from the microphone 141 to the loudspeakers 147. The loudspeakers 147 are configured to convert the processed output signals (i.e., directed sound signals) from the acoustic processor 143 into directed sound and transmit the directed sound towards a point in space based on a direction received by the acoustic processor 143 from the direction sensor 145.

The directed sound signals may vary for each particular loudspeaker in order to provide the desired sound at the point in space. For example, the directed sound signals may vary based on a transmitting delay to allow beamforming at the point in space. The directed sound signals may also be transmitted in a higher frequency band and shifted back down to the voice band at a receiver at the point in space. An ultrasonic frequency band, for example, may even be used. Using audio frequency-shifting can provide greater directivity using a smaller array of loudspeakers, and possibly more privacy. To increase privacy even more, the frequency shifting could follow a random hopping pattern. When employing the frequency-shifting, a person receiving the directed sound signal at the point in space would use a special receiver configured to receive the transmitted signal and shift the signal down to base-band.

The directed sound signals may also vary to allow stereo sound at the point in space. To provide stereo sound, the loudspeakers may be divided into left and right loudspeakers with each loudspeaker group receiving different directed sound signals to provide stereo sound at the point in space. Alternatively, the entire array of loudspeakers could be driven simultaneously by the sum of two sets of directed sound signals.

The acoustic processor 143 employs the received direction, the known relative position of the loudspeakers 147 to one another and the orientation of the loudspeakers 147 to direct each loudspeaker of the loudspeakers 147 to transmit the directed sound to the point in space. The loudspeakers 147 are configured to provide the directed sound based on the received acoustic signals (i.e., the raw sound in FIG. 1B) and according to directional signals provided by the acoustic processor 143. The directional signals are based on the direction provided by the direction sensor 145 and may vary for each of the loudspeakers 147.

The direction sensor 145 is configured to determine the direction by determining where a user's attention is directed. The direction sensor 145 may therefore receive an indication of head direction, an indication of eye direction, or both, as FIG. 1B indicates. The acoustic processor 143 is configured to generate the directional signals for each individual loudspeaker of the loudspeakers 147 based on the determined direction. If multiple directions are indicated by the user, then the acoustic processor 143 can generate directional signals for the loudspeakers 147 to simultaneously transmit directed sound to the multiple directions indicated by the user.

FIG. 1C illustrates a block diagram of an embodiment of a directional communication system 150 constructed according to the principles of the present disclosure. The directional communication system 150 includes multiple components that may be included in the directional sound system 140 of FIG. 1B. These corresponding components have the same reference number. Additionally, the directional communication system 150 includes acoustic transducers 151, a controller 153 and a loudspeaker 155.

The directional communication system 150 allows enhanced communication by providing directed sound to a spatial location and receiving enhanced sound from the spatial location. The acoustic transducers 151 are configured to operate as microphones and loudspeakers. The acoustic transducers 151 may be an array such as the loudspeaker array 230 of FIG. 2A and FIG. 4 or the microphone array disclosed in Marzetta. In one embodiment, the acoustic transducers 151 may be an array of loudspeakers and an array of microphones that are interleaved. The controller 153 is configured to direct the acoustic transducers 151 to operate as either microphones or loudspeakers. The controller 153 is coupled to both the acoustic processor 143 and the acoustic transducers 151. The acoustic processor 143 may be configured to process signals transmitted to or received from the acoustic transducers 151 according to a control signal received from the controller 153. The controller 153 may be a switch, such as a push button switch, that is activated by the user to switch between transmitting and receiving sound from the spatial location. In some embodiments, the switch may be operated based on a head or eye movement of the user that is sensed by the direction sensor 145. As indicated by the dashed box in FIG. 1C, the controller may be included within the acoustic processor 143 in some embodiments. The controller 153 may also be used by a user to indicate multiple spatial locations.

The loudspeaker 155 is coupled, wirelessly or by wire, to the acoustic processor 143. The loudspeaker 155 is configured to convert an enhanced sound signal generated by the acoustic processor 143 into enhanced sound as disclosed in Marzetta.

FIG. 2A schematically illustrates a relationship between the user 100 of FIG. 1A, a point of gaze 220 and an array of loudspeakers 230, which FIG. 2A illustrates as being a periodic array (one in which a substantially constant pitch separates loudspeakers 230a to 230n). The array of loudspeakers 230 may be the loudspeakers 147 illustrated in FIG. 1B or the acoustic transducers 151 of FIG. 1C. FIG. 2A shows a topside view of a head 210 of the user 100 of FIG. 1A. The head 210 has unreferenced eyes and ears. An unreferenced arrow leads from the head 210 toward the point of gaze 220 which is a spatial location. The point of gaze 220 may, for example, be a person with whom the user is engaged in a conversation or a person whom the user would like to direct sound. Unreferenced sound waves emanate from the array of loudspeakers 230 to the point of gaze 220 signifying acoustic energy (sounds) directed to the point of gaze 220.

The array of loudspeakers 230 includes loudspeakers 230a, 230b, 230c, 230d, . . . , 230n. The array of loudspeakers 230 may be a one-dimensional (substantially linear) array, a two-dimensional (substantially planar) array, a three-dimensional (volume) array or any other configuration.

Delays, referred to as transmitting delays, may be associated with each loudspeaker of the array of loudspeakers 230 to control when the sound waves are sent. By controlling when the sound waves are sent, the sound waves can arrive at the point of gaze 220 at the same time. Therefore, the sum of the sound waves will be perceived by a user at the point of gaze 220 to provide an enhanced sound. An acoustic processor, such as the acoustic processor 143 of FIG. 1B, may provide the necessary transmitting delays for each loudspeaker of the array of loudspeakers 230 to allow the enhance sound at the point of gaze 220. The acoustic processor 143 may employ directional information from the direction sensor 145 to determine the appropriate transmitting delay for each loudspeaker of the array of loudspeakers 230.

Angles θ and φ (see FIG. 2A and FIG. 4) separate a line 240 normal to the line or plane of the array of loudspeakers 230 and a line 250 indicating the direction between the point of gaze 220 and the array of loudspeakers 230. It is assumed that the orientation of the array of loudspeakers 230 is known (perhaps by fixing them with respect to the direction sensor 145 of FIG. 1B). The direction sensor 145 of FIG. 1B determines the direction of the line 250. The line 250 is then known. Thus, the angles θ and φ may be determined. Directed sound from the loudspeakers 230a, 230b, 230c, 230d, . . . , 230n may be superposed based on the angles θ and φ to yield enhanced sound at the point of gaze 220.

In an alternative embodiment, the orientation of the array of loudspeakers 230 is determined with an auxiliary orientation sensor (not shown), which may take the form of a position sensor, an accelerometer or another conventional or later-discovered orientation-sensing mechanism.

FIG. 2B schematically illustrates one embodiment of a non-contact optical eye tracker that may constitute the direction sensor 145 of the directional sound system of FIG. 1B or the directional communication system of FIG. 1C. The eye tracker takes advantage of corneal reflection that occurs with respect to a cornea 282 of an eye 280. A light source 290, which may be a low-power laser, produces light that reflects off the cornea 282 and impinges on a light sensor 295 at a location that is a function of the gaze (angular position) of the eye 280. The light sensor 295, which may be an array of charge-coupled devices (CCD), produces an output signal that is a function of the gaze. Of course, other eye-tracking technologies exist and fall within the broad scope of the disclosure. Such technologies include contact technologies, including those that employ a special contact lens with an embedded mirror or magnetic field sensor or other non-contact technologies, including those that measure electrical potentials with contact electrodes placed near the eyes, the most common of which is the electro-oculogram (EOG).

FIG. 3 schematically illustrates one embodiment of a directional sound system 300 having an accelerometer 310 and constructed according to the principles of the disclosure. Head position detection can be used in lieu of or in addition to eye tracking. Head position tracking may be carried out with, for example, a conventional or later-developed angular position sensor or accelerometer. In FIG. 3, the accelerometer 310 is incorporated in, or coupled to, eyeglass frame 320. Loudspeakers 330, or at least a portion of a loudspeaker array, may likewise be incorporated in, or coupled to, the eyeglass frame 320. Conductors (not shown) embedded in or on the eyeglass frame 320 couple the accelerometer 310 to the loudspeakers 330. The acoustic processor 143 of FIG. 1B may likewise be incorporated in, or coupled to, the eyeglass frame 320 as illustrated by the box 340. The acoustic processor 340 can be coupled by wire to the accelerometer 310 and the loudspeakers 330. In the embodiment of FIG. 3, an arm 350 couples a microphone 360 to the eyeglass frame 320. The arm 350 may be a conventional arm that is employed to couple a microphone to an eyeglass frame 320 or a headset. The microphone 360 may also be a conventional device. The arm 350 may include wire leads that connect the microphone 360 to the acoustic processor 340. In another embodiment, the microphone 360 may be electrically coupled to the acoustic processor 340 through a wireless connection.

FIG. 4 schematically illustrates a substantially planar, regular two-dimensional m-by-n array of loudspeakers 230. Individual loudspeakers in the array are designated 230a-1, . . . , 230m-n and are separated on-center by a horizontal pitch h and a vertical pitch v. The loudspeakers 230 may be considered acoustic transducers as indicated below. In the embodiment of FIG. 4, h and v are not equal. In an alternative embodiment, h=v. Assuming acoustic energy from the acoustic processor 143 to be directed to the point of gaze 220 of FIG. 2A, one embodiment of a technique for directing sound delivered to the point of gaze 220 will now be described. The technique describes determining the relative time delay (i.e., the transmitting delay) for each of the loudspeakers 230a-1, . . . 230m-n, to allow beamforming at the point of gaze 220. Determining the transmitting delay may occur in a calibration mode of the acoustic processor 143.

In the embodiment of FIG. 4, the relative positions of the loudspeakers 230a-1, . . . , 230m-n are known, because they are separated on-center by known horizontal and vertical pitches. In an alternative embodiment, the relative positions of the loudspeakers 230a-1, . . . , 230m-n may be determined by employing a sound source proximate to the point of gaze 220. The loudspeakers 230a-1, . . . , 230m-n can also be used as microphones to listen to the sound source and the acoustic processor 143 can obtain a delayed version of the sound source from each of the loudspeakers 230a-1, . . . , 230m-n based on the relative position thereto. The acoustic processor 143 can then determine the transmitting delay for each of the loudspeakers 230a-1, . . . , 230m-n. A switch, such as the controller 153 can be operated by the user 100 to configure the acoustic processor 143 to receive the sound source from the loudspeakers 230a-1, . . . , 230m-n for determining the transmitting delays. Additionally, a microphone array such as disclosed in Marzetta may be interleaved with the array of loudspeakers 230.

In another embodiment, the acoustic processor 143 may initiate the calibration mode to determine the transmitting delays for each of the loudspeakers 230a-1, . . . , 230m-n with respect to the point of gaze by employing one of the loudspeakers 230a-1, . . . , 230m-n to transmit an audio signal to the point of gaze 220. The other remaining loudspeakers may be used as microphones to receive a reflection of the transmitted audio signal. The acoustic processor 143 can then determine the transmitting delays from the reflected audio signal received by the remaining loudspeakers 230a-1, . . . , 230m-n. This process may be repeated for multiple of the loudspeakers 230a-1, . . . , 230m-n. Processing of the received reflected audio signals, such as filtering, may be necessary due to interference from objects.

The calibration mode may cause acoustic energy to emanate from a known location or determine the location of emanating acoustic energy (perhaps with a camera), capturing the acoustic energy with the loudspeakers (being used as microphones) and determining the amount by which the acoustic energy is delayed with respect to each loudspeaker. Correct transmitting delays may thus be determined. This embodiment is particularly advantageous when loudspeaker positions are aperiodic (i.e., irregular), arbitrary, changing or unknown. In additional embodiments, wireless loudspeakers may be employed in lieu of, or in addition to, the loudspeakers 230a-1, . . . , 230m-n.

FIG. 5 illustrates an example of an embodiment of calculating transmitting delays for the loudspeakers 230a-1, . . . , 230m-n according to the principles of the disclosure. For the following discussion, the loudspeakers 230a-1, . . . , 230m-n may be considered as an array of acoustic transducers and may be referred to as microphones or loudspeakers depending on the instant application. In FIG. 5, three output signals of three corresponding acoustic transducers (operating as microphones) 230a-1, 230a-2, 230a-3 and integer delays (i.e., relative delay times) thereof are illustrated. Additionally, delay-and-sum beamforming performed at the point of gaze 220 with respect to the acoustic transducers operating as loudspeakers is also illustrated. For ease of presentation, only particular transients in the output signals are shown, and are idealized into rectangles of fixed width and unit height. The three output signals are grouped in groups 510 and 520. The signals as they are received by the acoustic transducers 230a-1, 230a-2, 230a-3 are contained in a group 510 and designated 510a, 510b, 510c. The signals after determining the transmitting delays and being transmitted to the point of gaze 220 are contained in a group 520 and designated 520a, 520b, 520c. 530 then represents a directed sound that is transmitted by the acoustic transducers 230a-1, 230a-2, 230a-3 to a designated spatial location (e.g., the gazing point 220) employing the transmitting delays. By providing the proper delay to each of the acoustic transducers 230a-1, 230a-2, 230a-3, the signals are superposed at the designated spatial location to yield a single enhanced sound.

The signal 510a contains a transient 540a representing acoustic energy received from a first source, a transient 540b representing acoustic energy received from a second source, a transient 540c representing acoustic energy received from a third source, a transient 540d representing acoustic energy received from a fourth source and a transient 540e representing acoustic energy received from a fifth source.

The signal 510b also contains transients representing acoustic energy emanating from the first, second, third, fourth and fifth sources (the last of which occurring too late to fall within the temporal scope of FIG. 5). Likewise, the signal 510c contains transients representing acoustic energy emanating from the first, second, third, fourth and fifth sources (again, the last falling outside of FIG. 5).

Although FIG. 5 does not show this, it can be seen that, for example, a constant delay separates the transients 540a occurring in the first, second and third output signals 510a, 510b, 510c. Likewise, a different, but still constant, delay separates the transients 540b occurring in the first, second and third output signals 510a, 510b, 510c. The same is true for the remaining transients 540c, 540d, 540e. This is a consequence of the fact that acoustic energy from different sources impinges upon the acoustic transducers 230a-1, 230a-2, 230a-3 at different but related times that is a function of the direction from which the acoustic energy is received.

One embodiment of the acoustic processor takes advantage of this phenomenon by delaying output signals to be transmitted by each of the acoustic transducers 230a-1, 230a-2, 230a-3 according to the determined relative time delay. The transmitting delay for each of the acoustic transducers 230a-1, 230a-2, 230a-3 is based on the output signal received from the direction sensor, namely an indication of the angle θ, upon which the delay is based.

The following equation relates the delay to the horizontal and vertical pitches and of the microphone relay:

$$d = \frac{( h sin θ cos ϕ + v sin θ sin ϕ )}{{V}_{s}}$$

where d is the delay, integer multiples of which the acoustic processor applies to the output signal of each microphone in the array, φ is the angle between the projection of the line 250 of FIG. 2A onto the plane of the array (e.g., a spherical coordinate representation) and an axis of the array, and Vₛ is the nominal speed of sound in air. Either h or v may be regarded as being zero in the case of a one-dimensional (linear) microphone array.

In FIG. 5, the transients 540a occurring in the first, second and third output signals 510a, 510b, 510c are assumed to represent acoustic energy emanating from the point of gaze (220 of FIG. 2A), and all other transients are assumed to represent acoustic energy emanating from other, extraneous sources. Thus, the appropriate thing to do is to determine the delay associated with the output signals 510a, 510b, 510c to determine transmitting delays such that directed sound transmitted to point of gaze 220 will constructively reinforce, and beam forming is achieved. Thus, the group 520 shows the output signal 520a delayed by a time 2d relative to its counterpart in the group 510, and the group 520 shows the output signal 520b delayed by a time d relative to its counterpart in the group 510.

The example of FIG. 5 may be adapted to a directional sound system or directional communication system in which the acoustic transducers are not arranged in an array having a regular pitch; d may be different for each output signal. It is also anticipated that some embodiments of the directional sound system or directional communication system may need some calibration to adapt them to particular users. This calibration may involve adjusting the eye tracker if present, adjusting the volume of the microphone, and determining the positions of the loudspeakers relative to one another if they are not arranged into an array having a regular pitch or pitches.

The example of FIG. 5 assumes that the point of gaze 220 is sufficiently distant from the array of loudspeakers such that it lies in the “Fraunhofer zone” of the array and therefore wavefronts of acoustic energy emanating between the loudspeakers and the point of gaze may be regarded as essentially flat. If, however, the point of gaze lies in the “Fresnel zone” of the array, the wavefronts of the acoustic energy emanating therefrom will exhibit appreciable curvature. For this reason, the transmitting delays that should be applied to the loudspeakers will not be multiples of a single delay d. Also, if point of gaze lies in the “Fresnel zone,” the position of the loudspeaker array relative to the user may need to be known. If embodied in eyeglass frames, the position will be known and fixed. Of course, other mechanisms, such as an auxiliary orientation sensor, could be used.

An alternative embodiment to that shown in FIG. 5 employs filter, delay and sum processing instead of delay-and-sum beamforming. In filter, delay and sum processing, a filter is applied to each loudspeaker such that the sums of the frequency responses of the filters add up to unity in the desired direction of focus. Subject to this constraint, the filters are chosen to try to reject every other sound.

FIG. 6 illustrates a flow diagram of one embodiment of a method of directing sound carried out according to the principles of the disclosure. The method begins in a start step 605. In a step 610, a direction in which a user's attention is directed is determined. In some embodiments, multiple directions may be identified by the user. In a step 620, directed sound signals are generated based on acoustic signals received from a microphone. The acoustic signals received from the microphone may be raw sounds from a user. An acoustic processor may generate the directed sound signals from the acoustic signals and directional data from a direction sensor. In a step 630, the directed sound signals are converted to directed sound employing loudspeakers having known positions relative to one another. In a step 640, the directed sound is transmitted to the direction employing the loudspeakers. In some embodiments, the directed sound may be simultaneously transmitted to the multiple directions identified by the user. The method ends in an end step 650.

Those skilled in the art to which this application relates will appreciate that other and further additions, deletions, substitutions and modifications may be made to the described embodiments.

What is claimed is:

1. A directional sound system, comprising:
a direction sensor configured to produce data for determining a direction in which attention of a user is directed;
a microphone configured to generate output signals indicative of sound received thereat;
loudspeakers configured to convert directed sound signals into directed sound; and
an acoustic processor configured to be coupled to said direction sensor, said microphone, and said loudspeakers, said acoustic processor configured to convert said output signals to said directed sound signals and employ said loudspeakers to transmit said directed sound to a spatial location associated with said direction.

2. The directional sound system as recited in claim 1 wherein said direction sensor is an eye tracker configured to provide an eye position signal indicative of a direction of a gaze of said user.

3. The directional sound system as recited in claim 1 wherein said direction sensor comprises an accelerometer configured to provide a signal indicative of a movement of a head of said user.

4. The directional sound system as recited in claim 1 wherein said loudspeakers are arranged in a substantially linear one-dimensional array.

5. The directional sound system as recited in claim 1 wherein said loudspeakers are arranged in a substantially planar two-dimensional array.

6. The directional sound system as recited in claim 1 wherein said acoustic processor is configured to apply a transmitting delay to said output signals according to integer multiples of a delay based on an angle between a direction of gaze by said user and a line normal to said loudspeakers.

7. The directional sound system as recited in claim 6 wherein said transmitting delay varies for each loudspeaker of said loudspeakers based on a distance between said each loudspeaker and said spatial location.

8. The directional sound system as recited in claim 1 wherein said direction sensor, said microphone and said acoustic processor are incorporated into an eyeglass frame.

9. The directional sound system as recited in claim 1 wherein said loudspeakers and said acoustic processor are located within a compartment.

10. The directional sound system as recited in claim 1 wherein at least some of said loudspeakers are wirelessly coupled to said acoustic processor and are located remotely from said user.

11. The directional sound system as recited in claim 1 wherein said direction sensor if further configured to produce data for determining multiple directions in which attention of a user is directed and said acoustic processor is further configured employ said loudspeakers to simultaneously transmit said directed sound to multiple spatial locations associated with said multiple directions.

12. A method of transmitting sound to a spatial location determined by the gaze of a user, comprising:
determining a direction of visual attention of a user associated with a spatial location;
generating directed sound signals indicative of sound received from a microphone;
converting said directed sound signals to directed sound employing loudspeakers having known positions relative to one another; and
transmitting said directed sound in said direction employing said loudspeakers to provide directed sound at said spatial location.

13. The method as recited in claim 12 wherein said determining comprises providing an eye position signal based on a direction of a gaze of the user.

14. The method as recited in claim 12 wherein said determining comprises providing a head position signal based on an orientation or a motion of a head of said user.

15. The method as recited in claim 12 wherein said loudspeakers are arranged in a substantially linear one-dimensional array.

16. The method as recited in claim 12 wherein said loudspeakers are arranged in a substantially planar two-dimensional array.

17. The method as recited in claim 12 wherein said converting includes applying a transmitting delay to said directed sound signals according to integer multiples of a delay based on an angle between a direction of gaze by said user and a line normal to said loudspeakers.

18. The method as recited in claim 17 wherein said transmitting delay varies for each loudspeaker of said loudspeakers based on a distance between said each loudspeaker and said spatial location.

19. A directional communication system, comprising:
an eyeglass frame;
a direction sensor on said eyeglass frame and configured to provide data indicative of a direction of visual attention of a user wearing said eyeglass frame;
a microphone configured to generate output signals indicative of sound received thereat;
acoustic transducers arranged in an array and configured to provide output signals indicative of sound received at said microphone; and
an acoustic processor coupled to said direction sensor, said microphone, and said acoustic transducers, said acoustic processor configured to convert said output signals to directed sound signals and employ said acoustic transducers to transmit directed sound based on said directed sound signals to a spatial location associated with said direction.

20. The directional communication system as recited in claim 19 further comprising an earphone coupled to said acoustic processor and configured to convert an enhanced signal into enhanced sound.

21. The directional communication system as recited in claim 20 wherein said acoustic transducers are further configured to provide input signals indicative of sound received at said user from a plurality of directions and said acoustic processor is further configured to superpose said input signals to produce said enhanced signal, said enhanced sound having a increased content of sound incident on said user from said direction of visual attention than sound received at said user.

22. The directional communication system as recited in claim 21 further comprising a controller configured to operate said acoustic transducers as microphones or loudspeakers.

23. The directional communication system as recited in claim 19 wherein frequency-shifting is employed to transmit said directed sound.
